(19) United States
(12) Patent Application Publication
(10) Pub. No.: US 2021/0164484 A1
(43) Pub. Date: Jun. 3, 2021

(54) PUMP WITH A LIFTING DEVICE

(71) Applicant: Sulzer Management AG, Winterthur (CH)

(72) Inventor: Andreas WILD, Bruchsal (DE)

(21) Appl. No.: 16/951,215

(22) Filed: Nov. 18, 2020

(30) Foreign Application Priority Data
Dec. 2, 2019 (EP) 19213013.6

(51) Int. Cl. F04D 29/06; F04D 29/42; F04D 29/66; F04D 29/046

(52) U.S. Cl. CPC F04D 29/06; F04D 29/046; F04D 29/66; F04D 29/42

(57) ABSTRACT

A pump includes a lifting device, a housing in which a shaft is arranged, a relief element connected to the shaft, and a contact element. The lifting device includes a spring and a thrust element. In a start-up or shut-down state, a spring force is transmitted to the shaft via the thrust element by the spring, separating the relief element and the counter element. The contact element is between the spring and the thrust element and a side of the thrust element facing the spring is flow-connected to a high-pressure side, and a side of the contact element facing the spring is flow-connected to a low-pressure side such that the thrust element and the contact element are spaced apart by a pressure difference generated between the side of the contact element facing the spring and the side of the contact element facing the thrust element.

### CROSS-REFERENCE TO RELATED APPLICATION

This application claims priority to European Patent Application No. 19213013.6, filed December 2, 2019, the contents of which are hereby incorporated herein by reference in their entirety.

### BACKGROUND

### Field of the Invention

The invention relates to a pump with a lifting device.

### Background Information

Conventional bearings can used wherever forces acting in certain directions have to be compensated or movements of an object in unwanted directions have to be prevented. Two types of bearings are essentially used in pumps, radial and axial bearings.

When centrifugal pumps are operated, an axial thrust is generated which acts in the direction of the suction side. To cancel this thrust, a relief disk is installed on the pressure side of the shaft, whose function depends on the pumping pressure. If the conveyed liquid does not have the necessary pressure, e.g. during start-up and shut down of the pump, the relief disk and the counter disk can come into contact. This causes wear, which can finally lead to the failure of the system. Lifting devices are used to bridge the critical phases during start-up and shut down. Since the relief disks lie on top of each other when the pump unit is at a standstill, at low speeds, i.e. during start-up and shut down of the pump unit, they come into contact with each other and thus cause wear. The reason for this is that a hydraulically stable balance of forces has not yet been established at the relief disks and therefore no relief gap can be created. In order to ensure a contactless start-up and shut down of the pump unit, displacement of the pump shaft is generated by lifting devices, forming a gap.

From EP 0 355 796 A2, a centrifugal pump with a lifting device and an electromagnetic hearing is known. Relief devices have long been used to compensate for the axial thrust of a running centrifugal pump. A typical relief device of a centrifugal pump comprises a rotating relief disk and a stationary relief counter disk forming a radially extending gap through which a portion of the fluid under pressure in the centrifugal pump flows to the outside. As a result, the shaft of the centrifugal pump is kept in a state of equilibrium in the axial direction, between the force caused by the axial thrust and the counter force caused by the relief device. During operation of the centrifugal pump, transitional phases can occur, for example during start-up or shut down, during which the fluid can have a low pressure so that the shaft cannot be kept in a state of equilibrium. In such a transitional situation, there is the risk that the two disks of the relief device touch each other, which could damage them. To avoid such damage, during the transitional phase or during the standstill of the centrifugal pump, a force is applied to the axial position of the shaft by a controlled electromagnet in such a way that the two disks of the relief device do not touch each other.

### SUMMARY

This known device has the disadvantage that the axial position of the shaft has to be detected by a sensor and has to be controlled by controllable electromagnets. The known device has the further disadvantage that on the one hand the maximum possible displacement path in the axial direction is very small and on the other hand the lifting device cannot be in contact with a conveyed liquid or a conveyed fluid, so that further seals are required.

From WO 2015/074903, a relief element is known, which is coupled to the shaft in a torque-proof manner. A throttle gap is formed with the counter element by arranging a device on the counter element to keep the relief element at a distance from the counter element. The device for keeping distance has a force element, preferably a spring, which generates a force in the opposite direction to the axial thrust. This known device has the disadvantage that the device for keeping distance presses against the relief element in the start-up state and the shut-down state and causes wear there.

It is therefore an object of the invention to provide a pump with a lifting device of a simple constructive design which avoids the adverse effects known from the state of the art, in particular both being able to be in contact with a conveyed fluid and having a reduced wear.

This object is met by a pump with the features described herein.

This disclosure further discusses advantageous embodiments of the invention.

Embodiments of the invention relates to a pump with a lifting device for compensating an axial thrust of a shaft of the pump in a predeterminable operating state of the pump, in particular during a start-up state and/or shut-down state. The pump comprises a housing having an inlet for a fluid on a low-pressure side and an outlet for the fluid on a high-pressure side of the pump, in which housing the shaft is arranged; and a relief element connected to the shaft in a torque-proof manner and a counter element connected to the housing. The pump is characterized in that the lifting device comprises a spring and a thrust element connected to the shaft in a torque-proof manner, and in that in a start-up state and/or shut-down state of the pump, a spring force directed in the opposite direction to the axial thrust can be transmitted to the shaft via the thrust element by the spring, so that the relief element and the corresponding counter element are separated from each other, wherein a contact element is arranged between the spring and the thrust element. A side of the contact element facing the thrust element is flow-connected to the high-pressure side in such a way, and a side of the contact element facing the spring is flow-connected to the low-pressure side in such a way that the thrust element and the contact element can be spaced apart by a pressure difference which can be generated between the side of the contact element facing the spring and the side of the contact element facing the thrust element.

This means that the spring can be expanded or compressed in the operating state. In the following, an axial thrust is generally understood to be the effect of a force acting in an axial direction on the shaft of the pump and which is caused by the rotation of the impellers of the pump. In the following, the spring is generally understood to be an element that generates a force in the opposite direction to the axial thrust, for example by the expansion of an elastic element. In particular, the spring is understood to be a spring which exerts a spring force correlating with the spring constant. For example, the spring can be designed as a spiral spring or a disk spring.

In the following, a start-up state is generally understood to be the state of the pump in which the pump is started and runs up, in particular the state in which no or an insufficient lubricant film is yet formed between the counter element and the relief element, in particular the state in which the spring force is so greater than the axial thrust that the relief element and the counter element are separated from each other. In the following, a shut-down state is generally understood to be the state of the pump in which the pump is stopped and shut down, in particular the state in which the lubricant film between the counter element and the relief element decreases, in particular the state in which the spring force is so greater than the axial thrust that the relief element and the counter element are separated from each other. In the following, a lubricating fluid is generally understood to be a substance with lubricating properties, in particular a lubricating fluid can also be a lubricant. In practice, the lubricating fluid can directly be the pumped product/fluid, so that the pump is designed as a product-lubricated pump.

In an operating state of the pump, a feed pressure is generated by the rotation of the shaft with the impellers of the pump, so that the fluid is conveyed from the inlet on the low-pressure side to the outlet on the high-pressure side of the pump. This feed pressure is used in the pump according to the invention to space the contact element and the thrust element from each other so that wear of the contact element and the thrust element can be avoided after the start-up state and/or before the shut-down state (i.e. in “normal” operating state). The lifting device can thus be protected from wear during the normal operating state by the device according to the invention, since frictional contact between the contact element and the thrust element is avoided by the feed pressure, or by the pressure difference of the feed pressure at different points of the pump. This means that there is no effect of the spring force on the thrust element.

On the other hand, during the start-up state and/or shut-down state, the relief element and the counter element are separated from each other by an axial pressure on the thrust element (the spring force of the spring) in order to prevent wear of the relief element and the counter element due to lack of lubrication. In particular, the spring force acts parallel to an axis of the shaft so that the axial thrust of the pump shaft can be compensated in the start-up state and/or shut-down state. After the start-up state, when a self-lubrication of the pump has started, a lubricant film forms between the relief element and the counter element, so that the relief element and counter element can run on each other substantially without wear by a lubricating film of a lubricating fluid between them. Preferably, the pump according to the invention can be a product-lubricated pump, so that the lubricating fluid corresponds to the conveyed fluid.

The pump according to the invention can comprise a relief chamber arranged in the housing, wherein the side of the contact element facing the spring is flow-connected to the low-pressure side via the relief chamber. The spring is preferably designed as a spiral spring, disk spring or as an elastic element. In particular, the contact element and the spring can be designed as a single component.

As an alternative, the spring can also be designed as a tension spring, that generates the spring force directed in the opposite direction to the axial thrust by a contraction and can be transmitted to the shaft via the thrust element. With this embodiment, the tension spring can be tensioned between the housing and the contact element to generate the spring force directed in the opposite direction to the axial thrust. The spring can be expanded by pressure which can be generated between the thrust element and the contact element in such a way that the contact element is spaced apart from the thrust element.

The pressure difference that can be generated can correspond to a pressure difference between a suction pressure and a pumping pressure of the pump. The suction pressure is a pressure at the inlet of the pump and the pumping pressure is a pressure at a pump stage of the pump. During the start-up state and/or shut-down state, the pressure difference between pumping pressure and suction pressure corresponds to a value in such a way that the contact element is moved in the direction of the thrust element (opposite direction to the axial thrust). There is no sufficiently large pressure difference to overcome the spring force, whereby the contact element is thus moved in the direction of the spring force and is thus in contact with the thrust element to separate the relief element and the corresponding counter element from each other. However, in a normal operating state, the suction pressure is lower than the pumping pressure, whereby the contact element is moved away from the thrust element (in the direction of the axial thrust), i.e. is moved in the opposite direction of the spring force, in order to avoid in this way the contact with the thrust element rotating with the shaft. A high-pressure chamber, which is arranged between the contact element and the thrust element, is filled with the fluid in the operating state and is under the pumping pressure (flow-connected to the pumping stage). A low-pressure chamber on the side of the contact element facing the spring (in which the spring is arranged) is filled with the fluid and is under the suction pressure (flow-connected to the inlet of the pump). The contact element and the spring are arranged on the pump housing. A seal can preferably be arranged between the contact element and the housing in order to seal the high-pressure chamber and the low-pressure chamber against each other. The seal is thus arranged between the contact element and the housing in such a way that the side of the contact element facing the spring and the side of the contact element facing the thrust element are sealed against each other.

In practice, the pump can be designed as a multistage pump with at least a first pump stage and a second pump stage. The side of the thrust element facing the spring is flow-connected to the first or second pump stage and the side of the contact element facing the spring is flow-connected to the suction side. The pumping pressure corresponds to the pressure of the first or second pump stage. As an alternative, the side of the contact element facing the spring can be flow-connected to the first pump stage and the side of the contact element facing the thrust element can be flow-connected to a higher pumping stage (pumping stage with higher pressure towards the outlet).

The contact element can be designed as a pressure ring, which is a disk-shaped ring, in particular a disk-shaped circular ring, which is arranged between the thrust element and the spring for force transmission and is usually made of a suitable metal or another suitable material, so that the axially acting spring forces can be suitably transmitted to the shaft via the thrust element by the pressure ring. In addition, the pump can comprise a plurality of contact elements, each of which is arranged between a spring and the thrust element. Thus, the pump can also comprise a plurality of springs, preferably an equal number of springs and contact elements. As an alternative, the pump can comprise a single spring, which is looped around the shaft (respectively a shaft stub/attachment), in particular around a cylindrical ring within the housing.

The shaft of the pump is rotatably supported in a shaft bearing. Here, the shaft bearing is preferably a pure radial bearing. The radial bearing is particularly preferably product-lubricated. Especially, the radial bearing can comprise silicon carbide or consist of silicon carbide. In practice, the radial bearing can be a plain bearing. An axial bearing of the pump can preferably be achieved by the relief element and the counter element. In principle, the relief element and/or the counter element can be designed as a disk.

The pump according to embodiments of the invention can thus be designed in particular as a pump with product-lubricated bearings, which generally has a very compact design, since most parts are in direct contact with the fluid. As a result, no additional oil-lubricated bearings are required and therefore no mechanical seals are needed to separate the bearings from the fluid. Due to this fact, the lifting device is designed in such a way that it can work with contact to the fluid.

In practice, the lifting device can be arranged on the drive side and/or the non-drive side. Preferably, the lifting device is arranged on the non-drive side at one end of the shaft.

In an embodiment of the invention, the relief element is preferably connected to the shaft in a torque-proof manner and the counter element is arranged stationary on the housing, i.e. immovably connected to the pump housing, so that a displacement from the relief element towards the counter element occurs by an axial movement of the shaft.

In a further embodiment of the invention important in practice, the spring can loop around the pump shaft, i.e. be arranged around the pump shaft, in particular around the cylindrical ring in the housing or around an attachment arranged on the end of the shaft (also shaft stub). In another specific embodiment of the invention, the lifting device can comprise a plurality of springs, in particular three or four springs, which are arranged at equal distances along a circumference of the shaft on the housing.

In addition, a contact surface of the relief element and/or of the counter element can be coated, in particular ceramic coated. Thus, the wear of both elements can be minimized. The relief element and/or the counter element can comprise a fiber-reinforced composite material or a thermo-plastic synthetic material, in particular a polyether ketone. The relief element and/or the counter element can be made of one or more of these materials, especially also of a composite material. However, due to the pump according to the invention, the relief element and the counter element can also be simply made of steel without having special coatings, since wear of the relief element and counter element is prevented by the lifting device. In particular, the costs of the relief element and counter element can also be reduced without premature wear.

### BRIEF DESCRIPTION OF THE DRAWINGS

The invention will be explained in more detail hereinafter with reference to the drawings.

FIG. 1 is a schematic representation of a pump according to an embodiment of the invention; and

FIG. 2 is a further schematic representation of a pump according to an embodiment of the invention.

### DETAILED DESCRIPTION

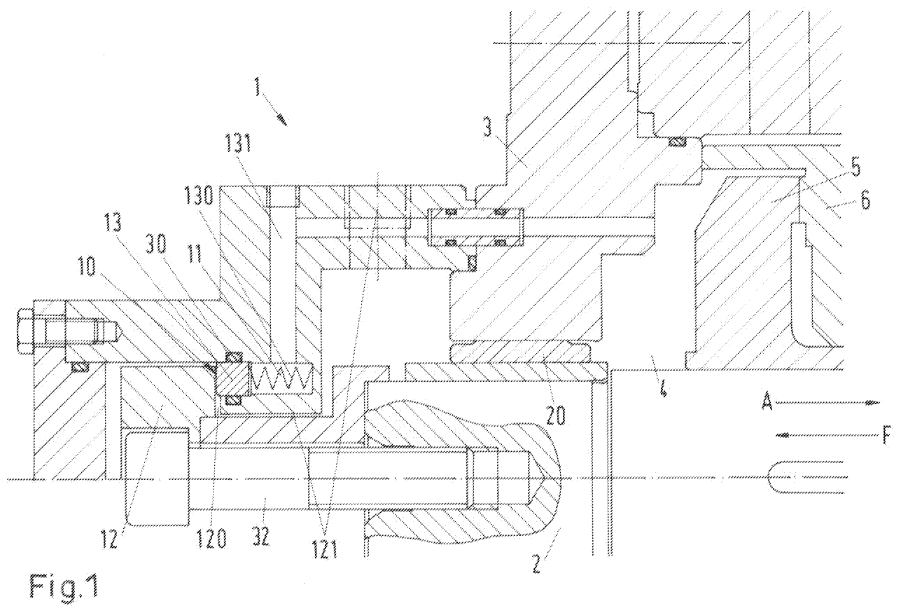

FIG. 1 shows a schematic representation of a pump 1 according to an embodiment of the invention.

The pump 1 according to an embodiment of the invention is designed as a product-lubricated multistage pump 1 and comprises a lifting device 10 for compensating an axial thrust A of a shaft 2 of the pump 1 in a predeterminable operating state, especially during a start-up state and/or shut-down state of the pump 1. Due to the fact that the pump 1 is product-lubricated, a very compact design is possible, because most parts are in direct contact with a fluid. As a consequence, no additional oil-lubricated bearings are required and therefore no mechanical seal is needed to separate the bearings from the fluid. Due to this fact, the lifting device 10 is designed in such a way that it can work with contact to the fluid.

Here, the pump 1 further comprises a housing 3 in which the shaft 2 is arranged, and which housing 3 comprises an inlet for a fluid on a low-pressure side and an outlet for the fluid on a high-pressure side of the pump, wherein the pump further comprises a relief element 5 connected to the shaft 2 in a torque-proof manner and a counter element 6 connected to the housing 3.

The lifting device 10 comprises a spring 11 and a thrust element 12 connected to the shaft 2 in a torque-proof manner. A contact element 13 is arranged between the spring 11 and the thrust element 12 which, like the spring 11, is arranged on the housing 3. In this embodiment, the housing 3 can be designed in several parts and comprise a pump housing and a housing part for the lifting device 10. The housing part for the lifting device 10 is arranged on the pump housing, in particular screwed on it.

In a start-up state and/or a shut-down state of the pump 1, a spring force F directed in the opposite direction to the axial thrust A is transmitted to the shaft 2 via the thrust element 12 by the spring 11, so that the relief element 5 and the corresponding counter element 6 are separated from each other. For this purpose, the spring 11 is designed as a pressure spring.

In an operating state of the pump 1, the feed pressure is generated by the rotation of the shaft 2 with the pump impellers (not shown here), so that the fluid is conveyed from the inlet on the low-pressure side to the outlet on the high-pressure side of the pump 1. This feed pressure is used in the pump 1 to space apart the contact element 13 and the thrust element 12 in a normal operating state, so that wear after the start-up state and/or before the shut-down state (i.e. in “normal” operating state) is avoided.

The lifting device 10 according to the invention can prevent wear during the normal operating state, since the side of the contact element 13 facing the thrust element 12 is flow-connected to the high-pressure side in such a way and the side of the contact element 13 facing the spring 11 is flow-connected to the low-pressure side in such a way that the thrust element 12 and the contact element 13 can be spaced apart by a pressure difference which can be generated between the side of the contact element 13 facing the spring 11 and the side of the contact element 13 facing the thrust element 12.

The fact that the thrust element 12 and the contact element 13 are spaced apart means that a distance between the spring 11 and the thrust element 12 is increased and a distance between the contact element 13 and the thrust element 12 is increased, whereby the spring 11 is compressed. As a consequence, the spring force F is not transmitted to the thrust element 12 in the normal operating state and there is no contact between thrust element 12 and contact element 13.

The pressure difference that can be generated corresponds to a pressure difference between a suction pressure and a pumping pressure of the pump 1. The suction pressure is a pressure at the inlet of the pump 1 and the pumping pressure is a pressure at a pump stage of the pump 1.

During the start-up state and/or shut-down state, the pressure difference between the pumping pressure and suction pressure corresponds to a value in such a way that the contact element 13 is moved in the direction of the thrust element 12, (opposite direction to the axial thrust A) i.e. is moved in the direction of the spring force F (to the left looking at FIG. 1) and is thus in contact with the thrust element 12 in order to separate the relief element 5 and the corresponding counter element 6 from each other. The spring force F thus overcomes the pressure difference between pumping pressure and suction pressure.

However, in the normal operating state, the suction pressure is so much lower than the pumping pressure (the spring force F is not great enough to overcome the pressure difference between pumping pressure and suction pressure) that the contact element 13 is moved away from the thrust element 12 (in the direction of the axial thrust A, to the right looking in FIG. 1), i.e. moved in the opposite direction to the spring force F, in order to avoid in this way the contact with the thrust element 12 rotating with shaft 2. A high-pressure chamber 120 is arranged between the contact element 13 and the thrust element 12. In the operating state, the high-pressure chamber 120 is filled with the fluid and is under the pumping pressure because it is flow-connected to the pump stage via the pipes/boreholes 121. A low-pressure chamber 130 on the side of the contact element 13 facing the spring 11, in which the spring 11 is arranged, is also filled with the fluid and is under the suction pressure, because it is flow-connected to the inlet of the pump 1 via the borehole/pipe, in particular flow-connected to the inlet of the pump 1 via the relief chamber 4. The contact element 13 and the spring 11 are arranged on the housing 3 of the pump 1.

A seal is arranged between the contact element 13 and the housing 3 to seal the high-pressure chamber 120 and the low-pressure chamber 130 against each other.

The shaft 2 of the pump 1 is rotatably supported in a shaft bearing 20. Here, the shaft bearing 20 is a pure radial bearing 20. The radial bearing 20 is product-lubricated and can comprise silicon carbide. An axial bearing of the pump 1 is achieved by the relief element 5 and the counter element 6.

The lifting device 10 is arranged on the non-drive side of the pump 1 and the thrust element 12 is preferably screwed onto a stub of the shaft 2 by a screw 32.

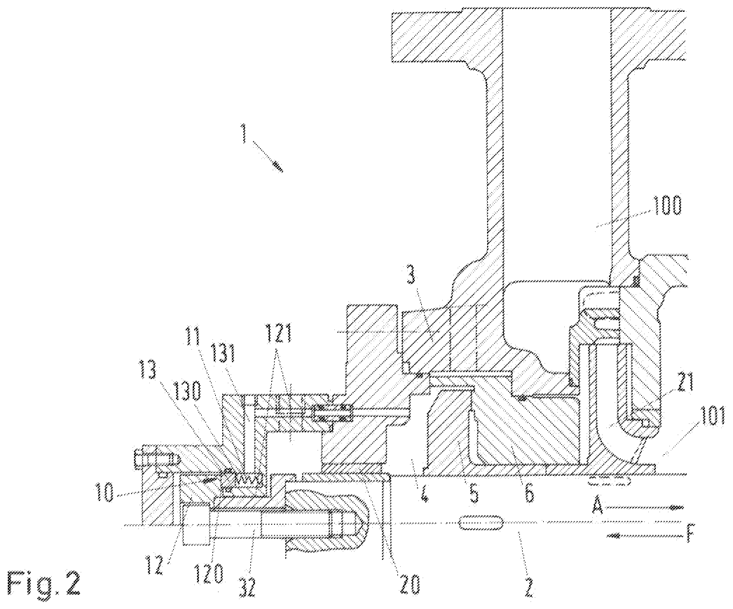

FIG. 2 shows a further schematic representation of a pump 1 according to the invention, which has an analogous structure to the pump according to FIG. 1.

In the operating state of the pump 1, the feed pressure is generated by the rotation of the shaft 2 with the pump impellers 21, so that the fluid is conveyed from the inlet on the low-pressure side to the outlet 100 on the high-pressure side of the pump 1. Due to the feed pressure, the contact element 13 and the thrust element 12 are spaced from each other in the normal operating state, so that wear of the spring 11/the contact element 13 and the thrust element 12 after the start-up state and/or before the shut-down state (i.e. in the “normal” operating state) is avoided.

The pressure difference that can be generated corresponds to the pressure difference between the suction pressure and the pumping pressure of the pump 1. The suction pressure is the pressure at the inlet of the pump 1 and the pumping pressure is the pressure at the pumping stage 101 of the pump 1.

During the start-up state and/or shut-down state, the pressure difference between the pumping pressure and suction pressure corresponds to a value in such a way that the contact element 13 is moved in the direction of the thrust element 12, (opposite direction to the axial thrust A), i.e. is moved in the direction of the spring force F (to the left looking at FIG. 2) and is thus in contact with the thrust element 12 in order to separate the relief element 5 and the corresponding counter element 6 from each other. This means that the spring force F overcomes the pressure difference between pumping pressure and suction pressure.

In the normal operating state, however, the suction pressure is so lower than the pumping pressure (the spring force F is not great enough to overcome the pressure difference between pumping pressure and suction pressure) that the contact element 13 is moved away from the thrust element 12 (in the direction of the axial thrust A, to the right looking at FIG. 2), i.e. is moved in the opposite direction to the spring force F, in order to avoid the contact with the thrust element 12 rotating with the shaft 2. The high-pressure chamber 120 is arranged between the contact element 13 and the thrust element 12. In the operating state, the high-pressure chamber 120 is filled with the fluid and is under the pumping pressure, because it is flow-connected to the pump stage 101 via the pipes/boreholes 121.

The low-pressure chamber 130 on the side of the contact element 13 facing the spring 11, in which the spring 11 is arranged, is also filled with the fluid and is under the suction pressure, because it is flow-connected to the inlet of the pump 1 via the borehole/pipe 131 and via the relief chamber 4 (since the relief chamber is flow-connected to the suction pipe of the pump).

What is claimed:

1. A pump comprising:
a lifting device configured to compensate for axial thrust of a shaft of the pump;
a housing having an inlet for a fluid on a low-pressure side and an outlet for the fluid on a high-pressure side of the pump, and in which the shaft is arranged;
a relief element connected to the shaft in a torque-proof manner and a counter element connected to the housing;
the lifting device comprising a spring and a thrust element connected to the shaft in a torque-proof manner, and in a start-up state or shut-down state of the pump, a spring force directed in an opposite direction to the axial thrust is capable of being transmitted to the shaft via the thrust element by the spring, so that the relief element and the counter element are separated from each other; and
a contact element arranged between the spring and the thrust element and a side of the thrust element facing the spring is flow-connected to the high-pressure side in such a way, and a side of the contact element facing the spring is flow-connected to the low-pressure side in such a way that the thrust element and the contact element are capable of being be spaced apart by a pressure difference which is configured to be generated between the side of the contact element facing the spring and the side of the contact element facing the thrust element.

2. The pump according to claim 1, further comprising a relief chamber arranged in the housing, the side of the contact element facing the spring being flow-connected to the low-pressure side via the relief chamber.

3. The pump according to claim 1, wherein the side of the contact element facing the spring is flow-connected to the inlet of the pump and the side of the thrust element facing the spring is flow-connected to a pumping stage of the pump so that the pressure difference which is configured to be generated corresponds to a pressure difference between a suction pressure and a pumping pressure of the pump.

4. The pump according to claim 1, wherein the contact element and the spring are arranged stationary on the housing.

5. The pump according to claim 1, wherein a seal is arranged between the contact element and the housing in such a way that the side of the contact element facing the spring and the side of the thrust element facing the spring are sealed against each other.

6. The pump according to claim 1, wherein the lifting device is arranged on one end of the shaft.

7. The pump according to claim 1, wherein the lifting device is arranged on a non-drive side of the pump.

8. The pump according to claim 1, wherein the pump is a multistage pump with at least a first pump stage and a second pump stage, and the side of the thrust element is included in one of the first or the second pump stage.

9. The pump according to claim 1, wherein the shaft is rotatably supported in a shaft bearing.

10. The pump according to claim 9, wherein the shaft bearing is a radial bearing.

11. The pump according to claim 9, wherein the shaft bearing is a plain bearing.

12. The pump according to claim 1, wherein the spring is a spiral spring or a disk spring.

13. The pump according to claim 1, wherein the pump is a product-lubricated pump.
